(19) United States
(12) Patent Application Publication
(10) Pub. No.: US 2011/0239470 A1
(43) Pub. Date: Oct. 6, 2011

(54) Helper Utensil

(76) Inventor: Keith Alfred Hemstreet, Hermosa Beach, CA (US)

(21) Appl. No.: 13/070,855

(22) Filed: Mar. 24, 2011

Related U.S. Application Data
(60) Provisional application No. 61/319,199, filed on Mar. 30, 2010.

(51) Int. Cl. A47J 43/28

(52) U.S. Cl. 30/327

(57) ABSTRACT

The present invention is a utensil that can be comfortably held simultaneously by two people, an adult and a young child and/or those with disabilities. A conventional spoon bowl is attached to a handle. The handle has a neck, which attaches to the bowl. Proceeding away from the bowl, the neck is adjacent to a child grip. The child grip is followed by a waist, and then an adult grip. The neck, child grip, waist, and adult grip taken in combination comprise the handle. The utensil is designed to allow the adult to guide the child and/or those with disabilities during the feeding process. The result is a utensil that is better than existing utensils at helping a child and/or those with disabilities to learn to feed themselves.

### CROSS REFERENCE TO RELATED APPLICATIONS

This application claims priority from U.S. Patent Application Ser. No. 61/319,199, entitled “Child Helper Spoon”, filed on 30 Mar. 2010. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to the field of infant feeding implements designed for very young children and/or those with disabilities. More specifically, the present invention relates to a novel and improved utensil for use by persons with limited or developing motor skills, such as infants and toddlers, and which is characterized in particular by a handle which is designed to be comfortably held simultaneously by two people, an adult and a young child or person with disabilities.

A conventional spoon bowl is attached to a handle. The handle has a neck, which attaches to the bowl. Proceeding away from the bowl, the neck is adjacent to a child grip. The child grip is followed by a waist, and then an adult grip. The neck, child grip, waist, and adult grip taken in combination comprise the handle.

### BACKGROUND OF THE INVENTION

The process of learning to self-feed is the process of developing the proper skills. Learning to hold and manipulate utensils requires a child and/or those with disabilities to develop skills such as eye-hand coordination, strength, and dexterity. Many people have recognized this and have invented utensils with the intent of partially addressing these issues.

U.S. Pat. No. 6,105,259, issued to Meyers et al. in 2000 stated, “ . . . when standard utensil designs are used by individuals having diminished capacity, such as small children or individuals having disabilities, the utensil may be difficult to grasp and retain. Furthermore, when used by an individual having diminished capacity, the utensil could be inserted an undesirable distance into the user's mouth, causing discomfort or injury. Accordingly, there exists a need for an eating utensil solving the above-identified problems.”

U.S. Pat. No. 4,563,816, issued to Jagger in 1986 stated, “Young children often find it difficult to grip and control cutlery since they lack the muscle control possessed by adults.”

U.S. Pat. No. 1,347,307, issued to E. G. Thomas in 1920 stated, “When a child begins the use of a spoon, it has yet to learn the coordination of its mind and muscles which comes from experience and in consequence it is not able to carry food to its mouth in spoons of the usual construction without spilling much of it so that for a time self feeding is a messy and unpleasant operation.”

Parents attempt to teach children to self-feed with existing fork and spoon designs, but existing forks and spoons were not designed to be held by the child and the adult at the same time. Therefore, the adult is forced to awkwardly guide the fork or spoon when the child is grasping it properly, or the child is forced to grab the spoon in the wrong place. What a parent has experienced is that when the parent holds a conventional child utensil such as a feeding fork or spoon properly, the child will grab a utensil such as a spoon where the handle and bowl intersect. This prevents the child from putting most of the spoon bowl into its mouth, and results in the child's hand and face being covered with food. Thus, when the parent holds a conventional child utensil correctly, the child is prevented from holding it correctly, and conversely, when the child holds the conventional child utensil correctly the parent is prevented from holding it correctly. Alternatively, the child will attempt to grab the spoon and will actually grab the adult's hand, which can spread food from the spoon or the child's hand to the adult's hand. This can also cause the child to become frustrated that the adult's hand is in the way. Furthermore, this sort of compromised feeding position is less likely to accurately teach the child to hold and use a spoon properly for self-feeding.

Therefore what is needed is a utensil that is designed to be held by the child and the adult at the same time. Such a utensil design would allow the child to hold and use the utensil properly for self-feeding while also providing the parent a grip to guide the utensil while the child is grasping it properly.

### SUMMARY OF THE INVENTION

The present invention is a utensil that can be comfortably held simultaneously by two people, an adult and a young child and/or those with disabilities. The utensil is designed to allow the adult to guide the child and/or those with disabilities during the feeding process. The result is a utensil that is better than existing utensils at helping a child and/or those with disabilities to learn to feed themselves.

The utensil of the present invention, in one embodiment, is illustrated as a conventional spoon bowl attached to a handle. The handle has a neck, which attaches to the bowl. Proceeding away from the bowl, the neck is adjacent to a child grip. The child grip is followed by a waist, and then an adult grip. The neck, child grip, waist, and adult grip taken in combination comprise the handle. The utensil is not limited to a spoon. The work element portion or working end of the utensil may be a spoon, fork, knife, or any other instrument that may be used in combination with the handle taught by the present invention.

Although many other utensils for feeding children are taught in the prior art, the present invention is novel and non-obvious because it has one or more of the following advantages. The helper utensil has a handle that is made to accommodate being held simultaneously by an adult and a child. The helper utensil has a handle that is of an appropriate size to accommodate being held simultaneously by an adult and a child. The helper utensil has a handle that is designed with an area for the child to grasp, and an area for the adult to grasp. The helper utensil allows the adult to more safely guide the child through the motions of self-feeding. The helper utensil enables the adult to more fully control the utensil during the self-feeding learning process in order to reduce potentially injurious motions or gestures by the child with the utensil. The helper utensil reduces the mess that can be created by a child learning to self-feed. The helper utensil allows the child to grip the utensil and learn the proper hand motions and coordination required to self-feed, while the adult is guiding the process. Finally, the helper utensil provides the child with a grip that is located on the handle in approximately the same relative position and plane to the working end, such as a spoon bowl found on conventional self-feeding spoons. This better prepares the child to use self-feeding spoons after it has learned to self-feed by using the helper utensil.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a top plan view of the child helper utensil spoon embodiment;

FIG. 2 is a side plan view of the child helper utensil spoon embodiment; and

FIG. 3 is a perspective view of an embodiment of the helper utensil in one potential use as intended.

### DETAILED DESCRIPTION OF THE INVENTION

In the following detailed description of the invention of exemplary embodiments of the present invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

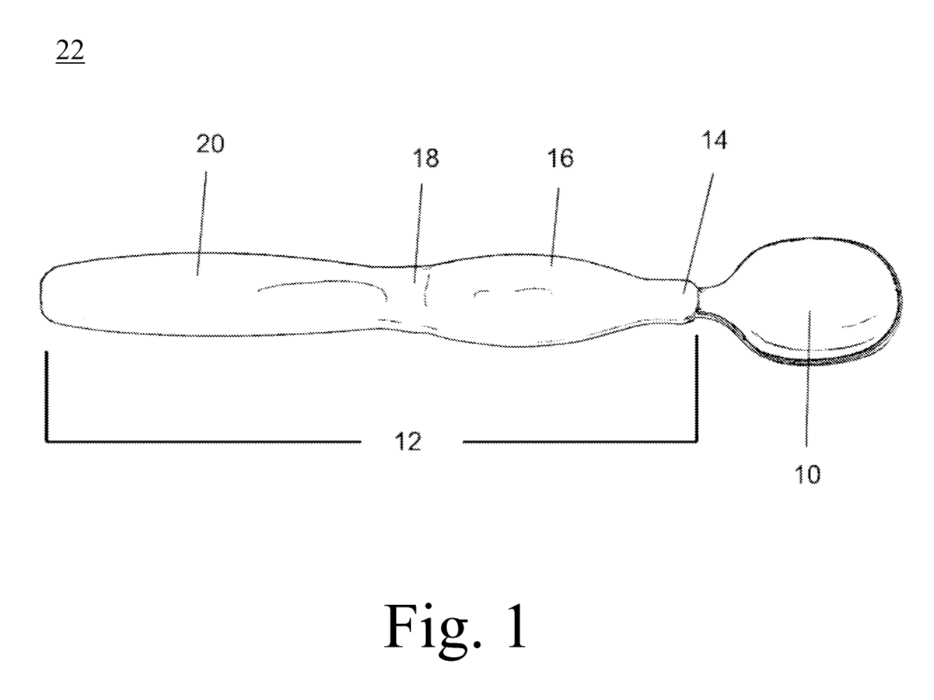

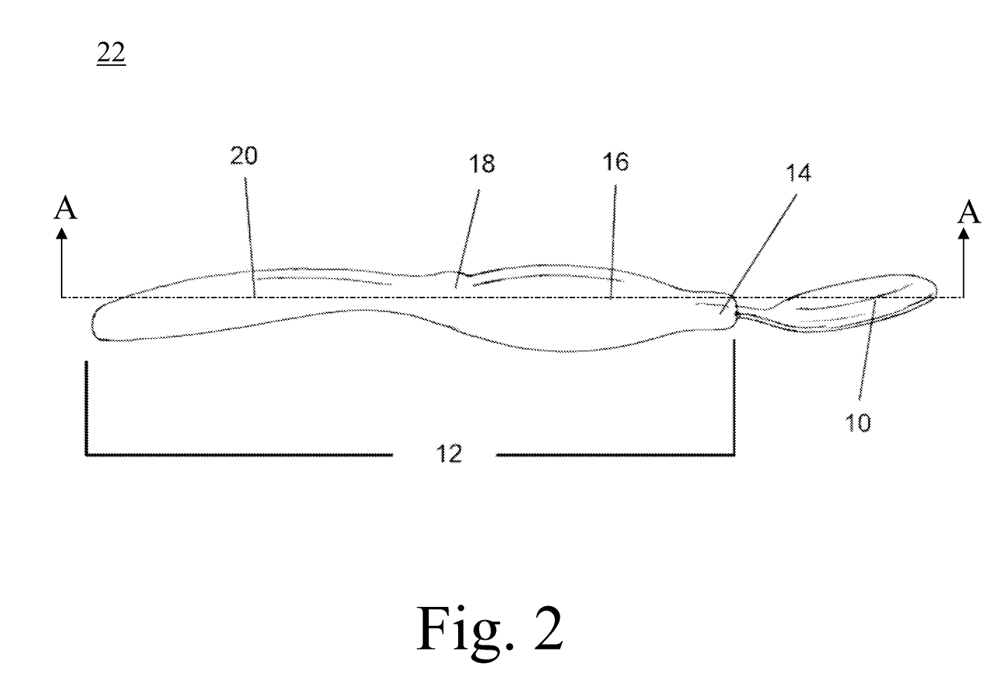

Referring to the figures, it is possible to see the various major elements constituting the apparatus of the present invention. Now referring to the Figures, the helper utensil is illustrated as a helper spoon 22 in this embodiment. FIG. 1 and FIG. 2 both show a helper spoon 22 comprising a conventional spoon bowl 10 attached to a handle 12. The handle 12 has a neck 14, which attaches to the bowl 10. Proceeding away from the bowl 10, the neck 14 is adjacent to a child grip 16. The child grip 16 is followed by a waist 18, and then an adult grip 20. The neck 14, child grip 16, waist 18, and adult grip 20 taken in combination comprise the handle 12 of the helper utensil/spoon 22.

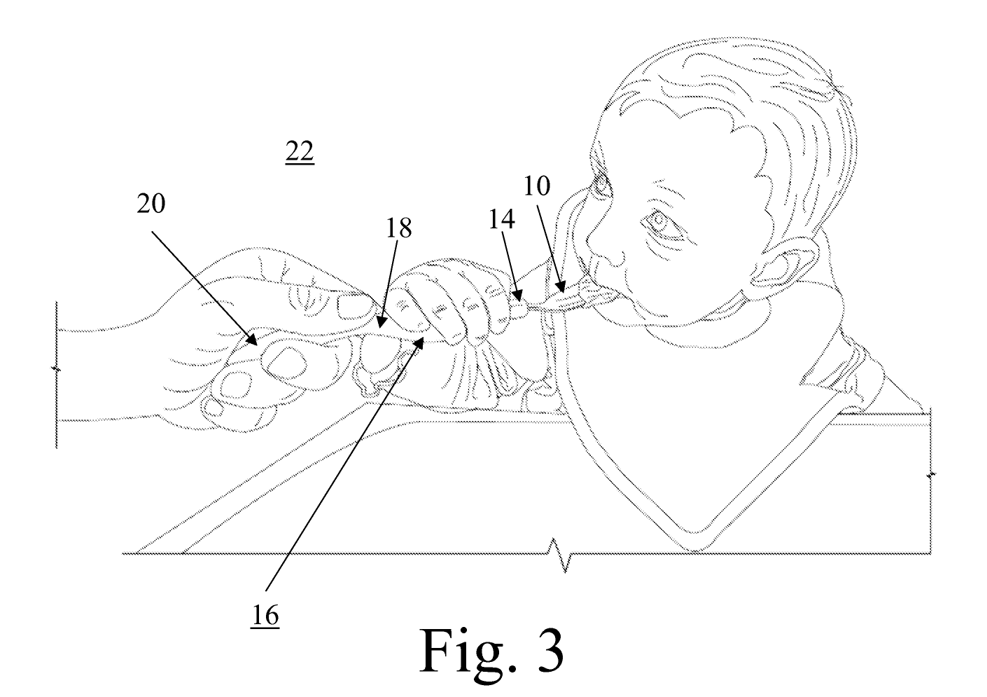

FIG. 3 shows a child being fed using the helper spoon 22. The left hand of an adult is holding the adult grip 20, and the right hand of a child is holding the child grip 16. The child is eating from the spoon bowl 10. To help a right-handed child to eat with the helper utensil/spoon 22, the adult would grasp the adult grip 20 with the left hand, and encourage the child to grasp the child grip 16 with its right hand. The adult would then move the helper utensil/spoon 22 through the eating process by scooping up food in the spoon bowl 10 of the utensil/spoon 22 and delivering the food to the mouth of the child. In this way, the child might come to develop the skills required to feed itself.

The helper utensil can be manufactured using similar techniques and materials as conventional child spoons and forks. For example, the entire utensil can be constructed of a single material as a single piece from such materials as plastic, wood, metal, ceramic, silicone, polypropylene, or any other material appropriate for a child-feeding utensil. Alternatively, the utensil can be made of more than one material, for example a rigid metal or plastic structure upon which a softer material can be added to make the child grip and/or the adult grip and/or the entire handle, and/or the spoon bowl more rigid.

The helper utensil of the present invention is superior to existing child feeding spoons and other utensils because it has a handle 12 that accommodates the child's hand and the adult's hand simultaneously in a natural and comfortable way. The handle 12 is contoured so there is a child appropriate portion, the child grip 16, and an adult appropriate portion, the adult grip 20. The child grip 16 is closer to the bowl 10 than the adult grip 20. The child grip 16 is the grip closest to the bowl 10 so that the child grip 16 and bowl 10 are in similar relative positions and a similar plane along lines A-A as will likely be found on spoons the child will use after becoming proficient at self-feeding.

In alternative embodiments of the present invention, the handle configuration that accommodates gripping by a child and an adult at the same time can be used in combination with any work element portion or working end which may be a fork, a knife, a toothbrush, a paintbrush, a comb, a writing implement, or any suitable utensil or tool that a child might need to learn to use. The spoon bowl, fork tines, or knife blade can be constructed of a different material than the handle. The spoon bowl, fork tines, or knife blade can have integrated safety features. The spoon bowl, fork tines, or knife blade can be made from or coated with temperature sensitive color changing material. The spoon bowl, fork tines, or knife blade can be coated with rubber or other soft material.

In still more alternative embodiments, the neck between the bowl and the child grip can be bent or can be flexible to change the angle of the bowl with respect to the child grip. The grip can be bent to change the angle of the work element portion with respect to the child grip so that the child grip on the handle portion and the work element portion are in different planes relative to each other. The waist between the child grip and the adult grip can be bent or can be flexible to change the angle of the child grip with respect to the adult grip. The waist can be bent to change the angle of the child grip with respect to the adult grip so that the child grip on the handle portion and the adult grip are in different planes relative to each other.

The shape of the child grip can be changed to any shape that a child can grasp. The shape of the adult grip can be changed to any shape that an adult can grasp. The materials of any part of the utensil can be changed. The length of the utensil can be changed. The utensil can be made of multiple parts, which can be detached from each other, and reattached for use. The utensil can be made of multiple parts, which can be exchanged with each other to assemble different configurations, such as to change the utensil from a spoon to a fork or knife.

The utensil is not limited to a spoon embodiment as illustrated by the Figures. The work element portion or working end of the utensil may be a spoon, fork, knife, or any other instrument that may be used in combination with the handle taught by the present invention. Additionally, the helper utensil and handle taught and claimed by the present invention is not limited to use by a child. Although the embodiment illustrated and discussed in detail is directed toward a child, the helper utensil may also be used by those with disabilities.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

The above illustrations provide one embodiment for implementing different features of the present invention. Specific embodiments of components and processes are described to help clarify the invention. These are, of course, merely embodiments and are not intended to limit the invention from that described in the claims.

Although the present invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A helper utensil comprising:
a work element portion;
a neck;
a child grip attached to the neck;
a waist attached to the child grip;
an adult grip attached to the waist;
wherein the neck, the child grip, the waist, and the adult grip combine to make a handle proceeding away from the bowl; and
the handle accommodates a first hand and a second hand simultaneously.

2. The helper utensil according to claim 1 in which the work element portion is either a spoon bowl, a fork with tines, a knife, a toothbrush, a paintbrush, a comb, or a writing implement.

3. The helper utensil according to claim 1 constructed of a single material as a single piece from plastic, wood, metal, ceramic, silicone, or polypropylene.

4. The helper utensil according to claim 1 wherein the work element portion and the handle portion are constructed from different materials.

5. The helper utensil according to claim 3 constructed from a rigid metal or plastic structure upon which a softer material is added to make the child grip, the adult grip, the entire handle, and the spoon bowl.

6. The helper utensil according to claim 1 in which the child grip is closer to the work element portion than the adult grip.

7. The helper utensil according to claim 2 in which the spoon bowl, fork tines, or knife blade can have integrated safety features.

8. The helper utensil according to claim 2 in which the spoon bowl, fork tines, or knife blade are made from or coated with temperature sensitive color changing material.

9. The helper utensil according to claim 2 in which the spoon bowl, fork tines, or knife blade are coated with rubber or a soft material.

10. The helper utensil according to claim 1 in which the child grip is the grip closest to the work element portion so that the child grip and the work element portion are in the same plane relative to each other.

11. The helper utensil according to claim 1 in which the neck between the work element portion and the child grip can be bent to change the angle of the work element portion with respect to the child grip so that the child grip on the handle portion and the work element portion are in different planes relative to each other.

12. The helper utensil according to claim 1 in which the neck between the work element portion and the child grip is flexible to change the angle of the work element portion with respect to the child grip so that the child grip on the handle portion and the work element portion are in different planes relative to each other.

13. The helper utensil according to claim 1 in which the waist between the child grip and the adult grip is bent to change the angle of the child grip with respect to the adult grip so that the child grip on the handle portion and the adult grip on the handle portion are in different planes relative to each other.

14. The helper utensil according to claim 1 in which the waist between the child grip and the adult grip is flexible to change the angle of the child grip with respect to the adult grip so that the child grip on the handle portion and the adult grip on the handle portion are in different planes relative to each other.

15. The helper utensil according to claim 1 in which the work element portion, the neck, the child grip attached to the neck, the waist attached to the child grip, and the adult grip attached to the waist; are constructed from individual parts which can be attached and detached from each other.

16. The helper utensil according to claim 1 in which the work element portion, the neck, the child grip attached to the neck, the waist attached to the child grip, and the adult grip attached to the waist; are constructed from individual parts which can be attached and detached from each other to assemble different configurations.

15. A utensil for use by infants, toddlers and people with disabilities comprising:
a work element portion;
a handle portion proceeding away from the work element portion;
the handle portion further comprising:
a neck;
a child grip attached to the neck;
a waist attached to the child grip;
an adult grip attached to the waist;
the handle accommodates a first hand and a second hand simultaneously on the child grip and the adult grip;
the adult grip is grasped by the adult's hand;
the child grip is grasped by the child's hand; and
the utensil is then guided by the adult hand through the eating process by scooping up food and delivering the food to the mouth of the child.

16. The utensil according to claim 15 in which the work element portion is either a spoon bowl, a fork with tines, a knife, a toothbrush, a paintbrush, a comb, or a writing implement.

17. The utensil according to claim 14 in which the child grip on the handle portion is closer to the work element portion than the adult grip on the handle portion.

18. The utensil according to claim 17 in which the child grip is the grip closest on the handle portion to the work element portion so that the child grip on the handle portion and the work element portion are in the same plane relative to each other.

19. The utensil according to claim 17 in which the neck on the handle portion between the work element portion and the child grip on the handle portion is flexible to change the angle of the work element portion with respect to the child grip on the handle portion so that the child grip on the handle portion and the work element portion are in different planes relative to each other.

20. The utensil according to claim 15 in which the waist of the handle portion between the child grip of the handle portion and the adult grip of the handle portion is flexible to change the angle of the child grip on the handle portion with respect to the adult grip on the handle portion so that the child grip on the handle portion and the adult grip on the handle portion are in different planes relative to each other.
